(19) United States
(12) Patent Application Publication
(10) Pub. No.: US 2014/0051417 A1
(43) Pub. Date: Feb. 20, 2014

(54) Number Port Error Resolution

(71) Applicant: SOLAVEI, LLC, Bellevue, WA (US)

(72) Inventors: Ryan K. Wuerch, Medina, WA (US); James P. Ryan, Bellevue, WA (US)

(73) Assignee: SOLAVEI, LLC, Bellevue, WA (US)

(21) Appl. No.: 13/828,565

(22) Filed: Mar. 14, 2013

Related U.S. Application Data
(60) Provisional application No. 61/684,462, filed on Aug. 17, 2012.

(51) Int. Cl. H04W 8/20

(52) U.S. Cl. CPC H04W 8/205
USPC 455/418

(57) ABSTRACT

Embodiments describe computing systems and methods for providing directed service activation error resolution to service subscribers. During service activation, a request to port a telephone number from an existing service of a subscriber to a new service of the subscriber is transmitted to a carrier activation service. In response to the request, an error message is received from the carrier activation service that indicates a number port error. Based on the error message, it is determined that the number port error is resolvable, and a user interface is provided to the subscriber that enables the subscriber to cause submission of a corrected request to port the telephone number.

### RELATED APPLICATIONS

This application claims priority from U.S. Provisional Application No. 61/684,462, entitled “Service Activation” and filed on Aug. 17, 2012, the entire contents of which are hereby incorporated herein in their entirety.

### BACKGROUND

Local Number Portability (LNP), including Wireless LNP (WLNP), as they are known in Canada and in the United States, enables a service subscriber to move their telephone number from one carrier to another. A “donor network” provides the current phone number to a “recipient network.” In the United States, standards for portability are defined by the Federal Communications Commission (FCC). A centralized database, called the National Portability Administration Center (NPAC) contains routing information for all ported numbers in the United States and Canada. When a provider receives a request to port a number, the provider sends a Local Service Request (LSR) to the existing service provider. The existing service provider sends a Firm Order Confirmation (FOC) to begin the number port process.

### BRIEF DESCRIPTION OF THE DRAWINGS

The following description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment suitable for providing service activation including number port error resolution.

FIGS. 2-7 illustrate example web interfaces for facilitating user-interactive device activation processes, including number port error resolution.

FIG. 8 illustrates an example process for resolving a number port error during service activation.

FIG. 9 is a block diagram of an example computing system usable to provide a social commerce platform.

### DETAILED DESCRIPTION

Embodiments of the present disclosure include activation services that enable a service subscriber to activate a service and to interactively resolve activation issues via the web or via a mobile device. The activation services may be related to a social commerce system that enables a social commerce community. A social commerce community may include members or entities that participate in the social commerce system. In one example, a social commerce community may be a community of members who have signed up for a service, such as a mobile phone service, an energy service, a cable service, or other service. The members may also participate in both offline and e-commerce activities that involve buying and selling of goods, buying electronic media, and so forth. The members have the opportunity to recruit additional members into the community. The recruited members become part of the member's network, and the member may be compensated based on the number of members (service subscribers) within his or her network, and may be compensated for other activities of the members in their networks, such as purchases made by the members within their network.

In some embodiments, the activation service enables subscribers to activate a mobile service. When a new member signs up for a new mobile service, the new member has the option of receiving a new mobile phone or a new subscriber identity module (SIM) card to use with an existing mobile phone. The new member also has the option of porting an existing mobile phone number to the new mobile phone service. If the number port attempt results in an error, then embodiments of the present disclosure provide an online mobile service activation service that enables the member to establish their account service. In some cases the member is able to resolve the number port error without contacting customer service. In particular, a mobile carrier provides port activation status codes to the social commerce platform, and the social commerce platform parses the codes and provides an online resolution process to the new member, such as via one or more user-interface screens as is described in more detail below.

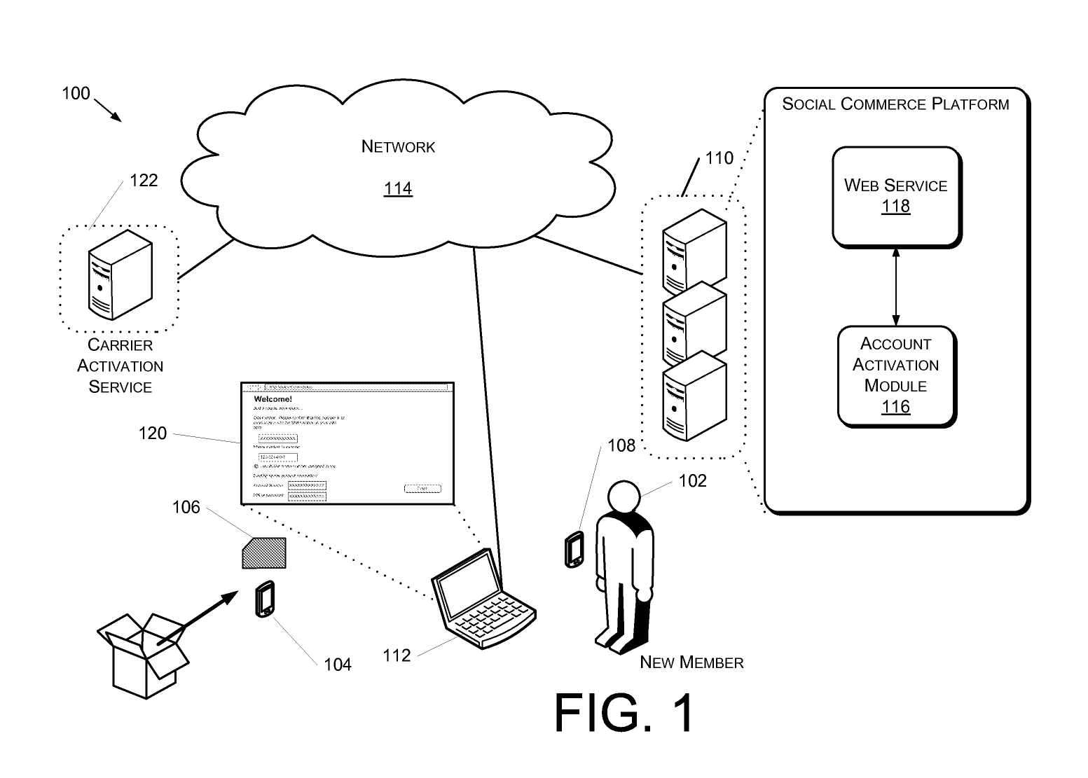

FIG. 1 illustrates an example environment 100 suitable for providing mobile service activation. After the new member 102 initially signs up for service, a new mobile device 104 and/or SIM card 106 may be shipped or otherwise delivered to the new member 102. The new member 102 may desire to use the SIM card 106 in an existing mobile device 108. Alternatively, the SIM card 106 may be used with the new mobile device 104, and may come pre-installed in the new mobile device 104.

Once the new member 102 receives the new mobile device 104 and/or the SIM card 106, the new member 102 accesses a social commerce platform 110 in order to activate his or her new mobile service. The new member may access the social commerce platform using a personal computer 112 via a network 114. The personal computer 112 may include a web browser or one or more applications for accessing an account activation module 116, such as via a web service 118. Alternatively, the new member 102 may access the account activation module 116 using a mobile device, such as the existing mobile device 108, in order to activate the new mobile service.

The account activation module 116 and/or the web service 118 may cause the personal computer 112 to display one or more interface(s) 120, which are interactive to allow the new member 102 to activate his or her member account within the social commerce platform 110, including activating the new mobile device 104 or the existing mobile device 108 for use with the new mobile service.

The new member 102 may provide information via interface(s) 120 in order to facilitate the activation. For example, the new member 102 may provide a SIM card number of the SIM card 106, an account number associated with the social commerce platform 110, an order number associated with the social commerce platform 110, an existing phone number that he or she wishes to port from an existing mobile service to the new mobile service, an account number and PIN/password associated with an existing mobile service, and so forth.

When attempting to port an existing number to the new mobile service, the new member 102 inputs the existing phone number and some account information associated with the existing mobile account via the interface(s) 120. The account activation module 116 receives this information, and interacts with a carrier activation service 122 in order to port the existing phone number to the new mobile service. The carrier activation service 122 may present one or more application programming interfaces (APIs) to the account activation module 116 in order to facilitate device activation and/or number porting, and the account activation module 116 may call the one or more APIs to request number ports and service set-up on behalf of the new member 102. In the example illustrated in FIG. 1, the carrier activation service 122 is shown as being separate from the social commerce platform 110. In various embodiments, the carrier activation service 122 is under control of a mobile carrier associated with the new mobile service. In some embodiments, the social commerce platform 110 and/or the social commerce service may be under the control of a separate entity that resells the mobile service of the mobile carrier. In other embodiments, the social commerce platform 110 and/or the social commerce service may under the control of an entity (such as a business entity) that also controls the mobile carrier. The carrier activation service 122 interacts with, for example, the mobile subscriber's existing carrier to port the number to the new mobile service.

The carrier activation service 122 returns status data, such as through an asynchronous update message, to the account activation module 116 regarding the account activation status. The status data may include one or more port activation messages. The account activation module 116 parses the status data returned by the carrier activation service 122, including any port activation messages, and determines a status of the account activation. The port activation messages may indicate one or more of the new service is active, that the number port has been successful, that the number port has failed, that port resolution is needed, and so forth. A number port error is indicated by a message or code indicating that the number port has failed, or a message or code indicating that port resolution is needed.

Some number port errors are resolvable by the new member 102 directly. For example, where the port error is the result of missing or inaccurate information (such as an inaccuracy in one or more of phone number, SIM card number, existing carrier account number, PIN, or password), then the account activation module 116 may provide the new member 102 with an opportunity to resolve the error directly by re-entering the correct information. The port error may not be resolvable by having the new member 102 re-enter the information, such as where it is determined that the port error is not the result of missing or inaccurate information. In that case, the account activation module 116 determines that there is a port failure, and provides the new member 102 with an opportunity to contact customer service to resolve the failure.

In any event, the account activation module 116 may cause an email or other notification to be sent to the new member 102 informing him or her of the status of their account activation, including where appropriate an indication that there has been a number port error. The email may invite the new member 102 to visit a web site (such as via the web service 118) to resolve the error or to contact customer service. The new member 102 may access one or more interface(s) 120 via the web service 118 in order to view information about the port error and/or to resolve the port error by re-entering their information or by contacting customer service. If the number port has been successful, then the account activation module 116 may cause an email or other notification to be sent to the new member 102 informing them of the successful mobile service activation and number port.

Various embodiments contemplate using information gathered from various sources to aid the activation process. For example, information may be gathered at the time that the new member 102 provides information via interface(s) 120. The information may include, but is not limited to, the type of device, whether the device is provided by the new member 102 or a new device is sought, SIM card type, service type, and whether a number is to be ported or a new number is sought. Additionally or alternatively, information may be gathered during the activation process. Such information may include, but is not limited to, status data such as port activation messages, which may include error information such as error codes regarding issues encountered during the number porting process, the activation process, or a combination thereof.

Various embodiments contemplate using the gathered information to assist and/or automate the activation process. For example, the gathered information may be leveraged to provide feedback to the new member or existing member to resolve any identified issues. Various embodiments contemplate providing specific and directed feedback to the new member or existing member on steps or actions to take to resolve the identified issue(s).

In various situations, providing feedback to the new member 102 or existing member may allow the new member 102 or existing member to activate the mobile service without manual intervention on the part of customer service personnel. For example, a new member 102 may resolve any issues on their own (e.g., self-serve) and/or an existing member may activate a new member on the new member's behalf

### Service Activation

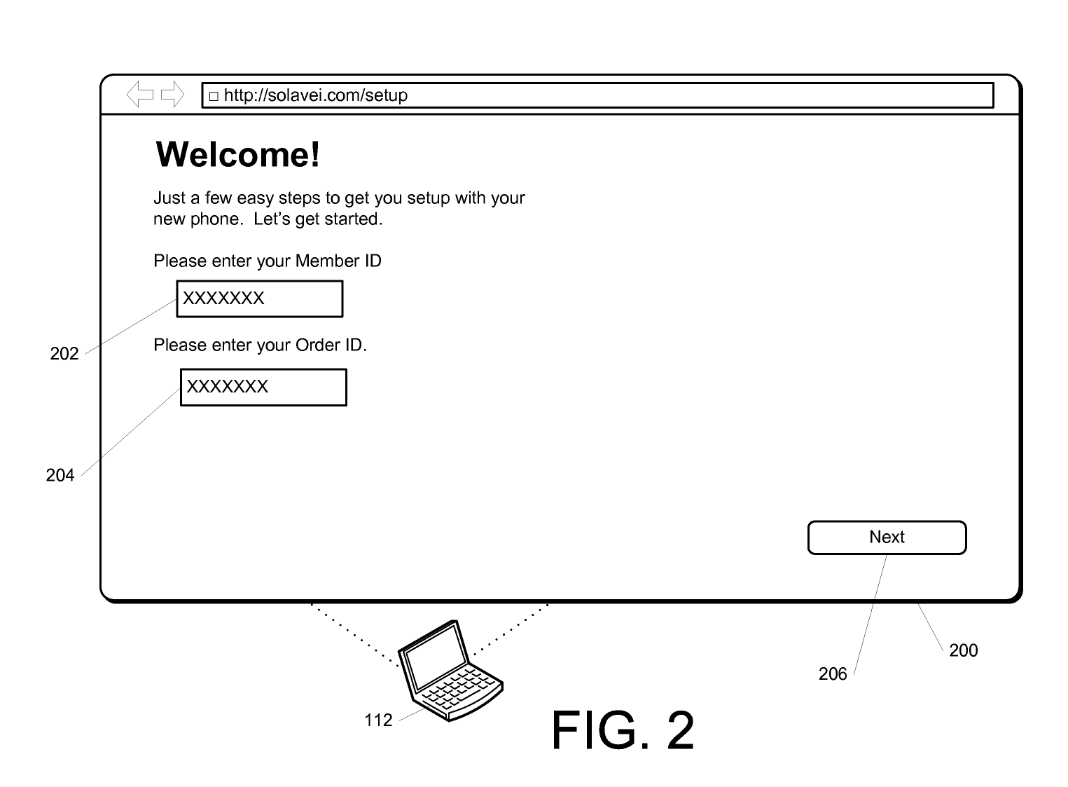

FIGS. 2-5 illustrate example web interfaces for facilitating device activation. FIG. 2 illustrates interface 200, which may be a web page that the new member 102 views during the device activation process. Interface 200 enables the new member 102 to enter their Member ID into field 202 and their Order ID into field 204, which may have been previously provided to the new member such as during a sign-up process, to begin the device activation process. Option 206 is selectable to submit the entered information.

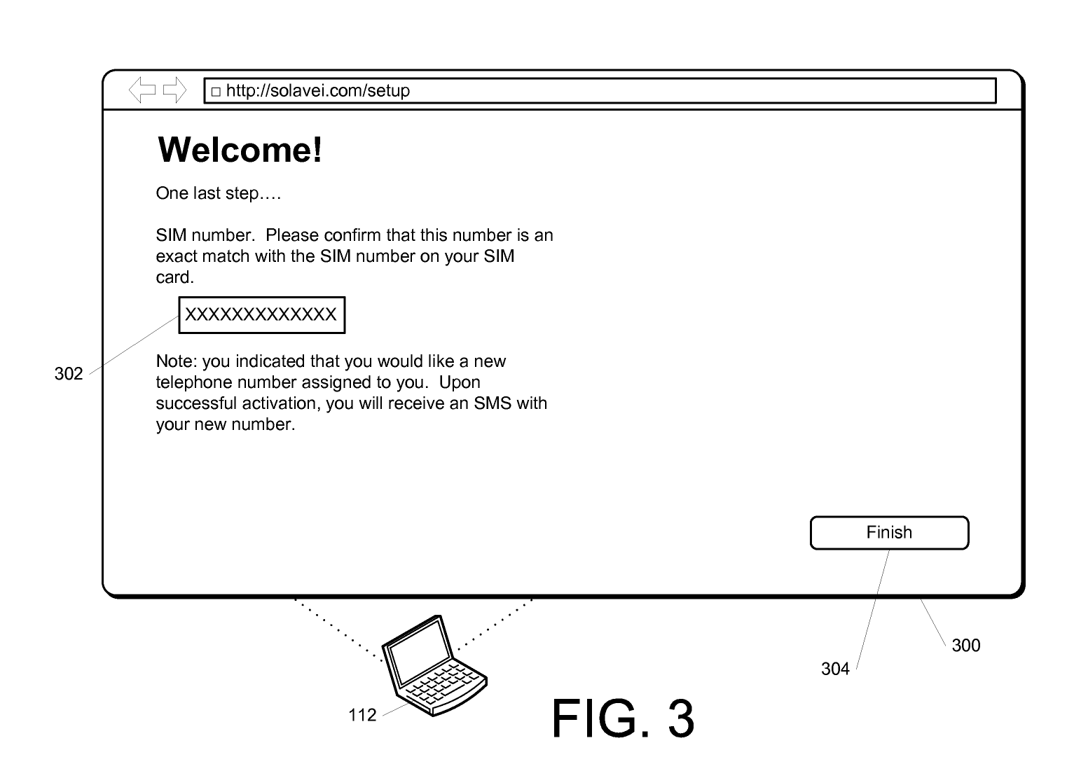

FIG. 3 illustrates interface 300, which may be displayed after selection of option 206 in interface 200 if the new member 102 is not porting an existing phone number. Interface 300 enables the new member 102 to enter the SIM card number of the SIM card 106 into field 302 in order to proceed with activating mobile service. Option 304 is selectable to complete the activation process.

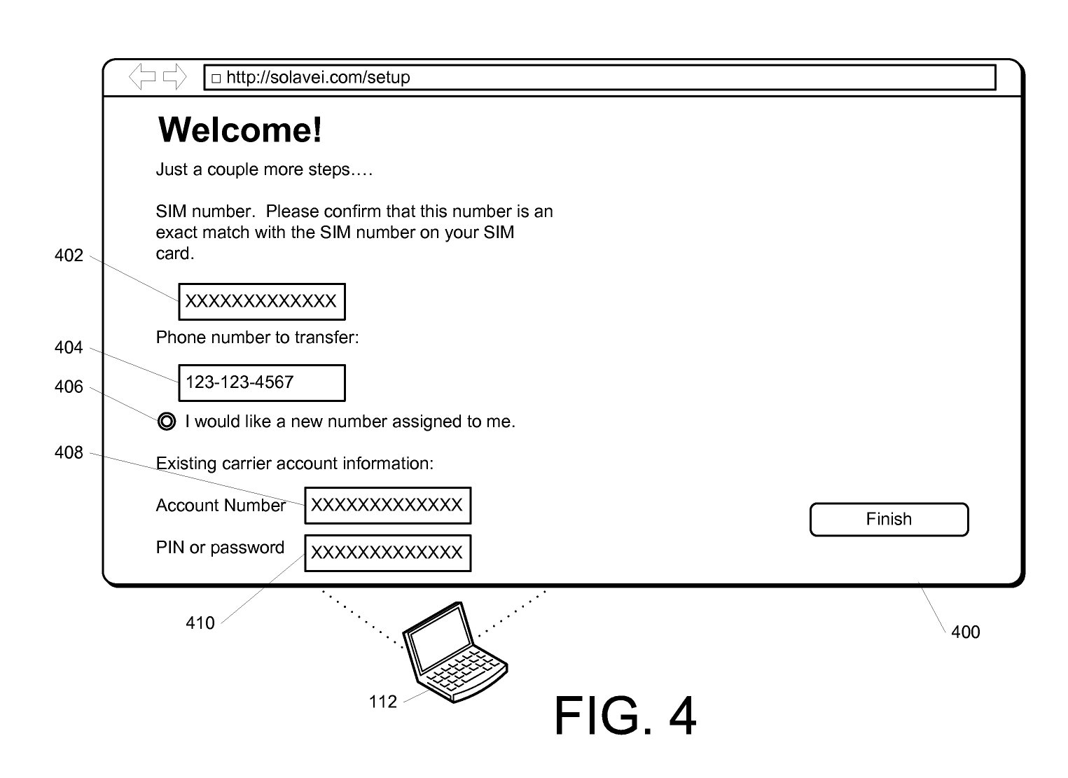

FIG. 4 illustrates interface 400, which may be displayed after selection of option 206 in interface 200 if the new member 102 is porting an existing phone number. Interface 400 enables the new member 102 to enter the SIM card number of the SIM card 106 into field 402 and his or her existing phone number into field 404. Field 404 may be pre-populated, such as where the new member 102 previously provided his or her existing phone number, such as during a sign-up process or at another time. Option 406 enables the new member to request that a new phone number be assigned to them instead of porting an existing phone number. Interface 400 enables the new member 102 to enter number port information, such as his or her existing carrier account credentials, including an account number into field 408 and a PIN or password associated with the existing carrier account into field 410. The existing carrier account is associated with an existing phone service from which the existing phone number is to be ported. Entering the existing phone number, account number, and PIN/password enables the carrier activation service 122 to port the existing phone number from the old carrier to the new carrier.

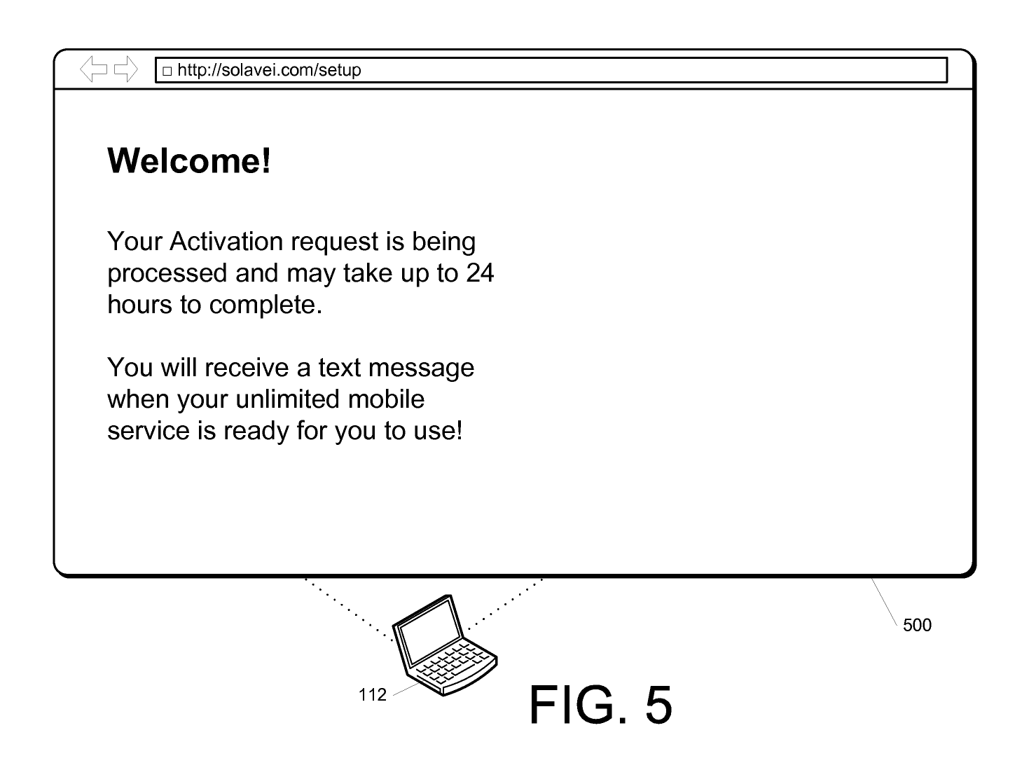

FIG. 5 illustrates interface 500, which informs the new member 102 that their activation request is in process, based on the information that the new member 102 has provided. At some point, the carrier activation service 122 will return a status of the activation, including one or more port activation messages. If the new member 102 logs onto the social commerce platform prior to that time, then the account activation module 116 may provide a message to the new member 102 informing them that the account activation and the number porting request are still pending.

### Number Port Resolution

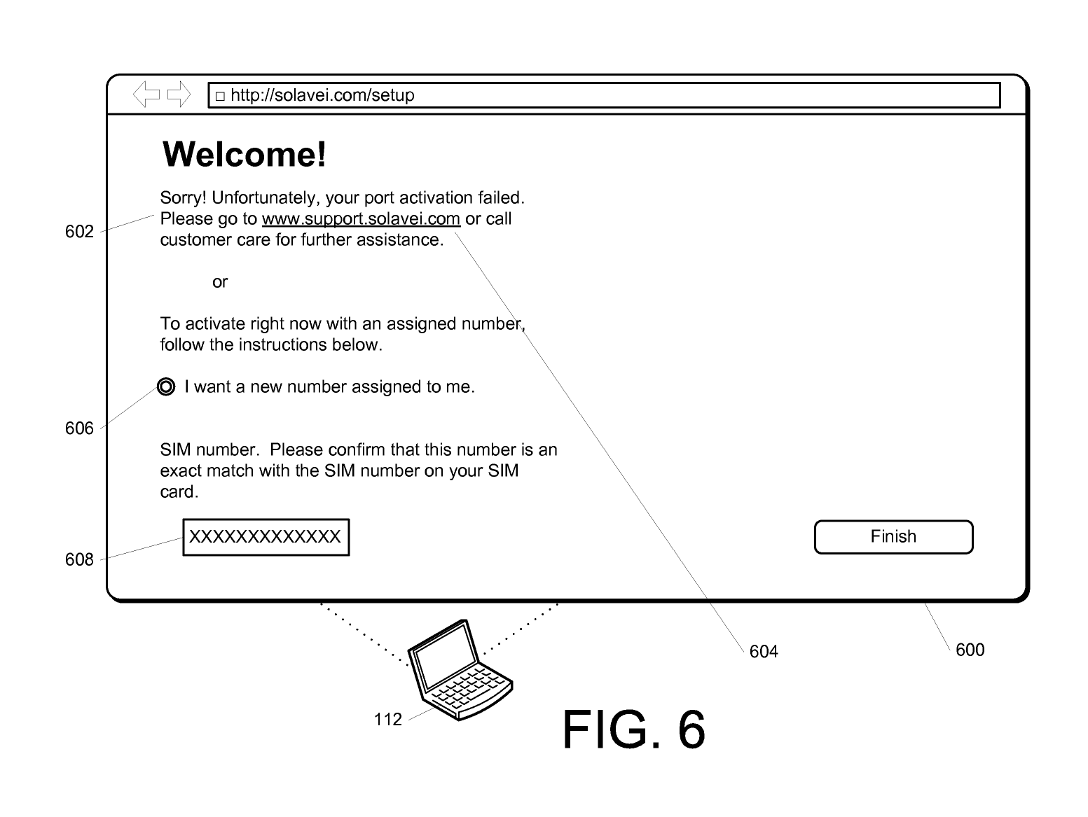

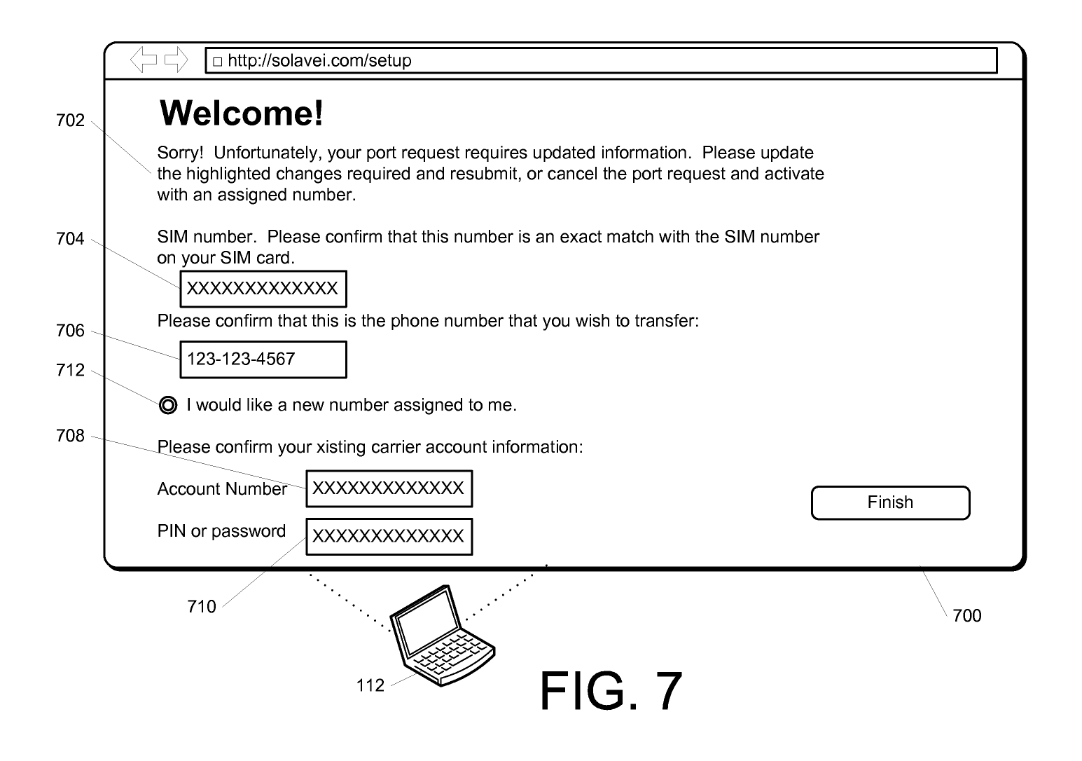

As noted above, there may be issues with account and device activation, including a number port failure. FIGS. 6 and 7 illustrate example web interfaces that enable the new member 102 to resolve activation issues, such as number porting errors and failures. FIG. 6 illustrates interface 600, which provides information 602 describing that the number port has failed in a way that is not resolvable by the service subscriber directly, without contacting customer service. Interface 600 may be provided to the new member 102, for example, when the number port failure is determined by the account activation module 116 to be caused by something other than missing or incorrect information in the number port request. A universal resource locator (URL) 604 is provided to enable the new member 102 to enable the new member 102 to contact a customer service representative to resolve the problem. Selectable option 606 enables the new member 102 to resolve the number port failure by requesting a new phone number be assigned instead of porting the existing number. Field 608 may be pre-populated with the SIM card number that the new member 102 previously provided to the account activation module 116, such as via interface 300. The new member 102 may verify that the SIM card number is correct and/or re-enter the SIM card number into field 608 before requesting a new phone number.

FIG. 7 illustrates interface 700, which provides information 702 that the number port activation indicates that resolution is needed. Interface 700 may be displayed to the new member 102 upon a determination by the account activation module 116 that the port activation message from the carrier activation service 122 indicates a number port error that is directly resolvable by the new member 102, such as through a directed process. The number port error may be directly resolvable by the new member 102, for example, when the number port request included missing or incorrect information. Fields 704, 706, 708, and 710 may be pre-populated with the information that the new member 102 previously provided during the account activation or sign-up process, such as via interface 400. The new member 102 may verify that the SIM card number, existing phone number, and credentials, such as the existing carrier account number and the PIN/password, are correct and fix any incorrect information. Alternatively, some or all of the fields 704, 706, 708, and 710 may be blank, thereby prompting the new member 102 to re-enter the information.

In various embodiments, the interface 700 may also indicate that previously provided information associated with a particular one of the fields has been determined to be incorrect, based for example on the port activation messages returned by the carrier activation service 122. For example, the account activation module 116 may determine that a port activation message indicates that the PIN or password provided with the port request does not match the previously provided account number. In that case, the account number field 708 and/or the PIN or password field 710 may be highlighted, be left blank (not pre-populated with the previously provided information), displayed along with an error indication such as an asterisk, an exclamation mark, a word (such as “error”), or other indicator, in order to prompt the new member 102 to re-enter that information. The interface 700 may also include a message that directly identifies one or more of the fields 704, 706, 708, and 710, or other information or field that needs to be reviewed by the new member 102.

Selectable option 712 enables the new member 102 to initiate resolution of the number port error by requesting a new phone number be assigned instead of porting the existing number.

Upon receipt of the information re-entered and/or verified via interface 700, the account activation module 116 resubmits the port request to the carrier activation service 122. The carrier activation service 122 may subsequently return a port activation message to the account activation module 116 indicating that the port is successful. Alternatively, the carrier activation service 122 may subsequently return a port activation message that indicates a failure status or a port resolution status of the number port request.

Example Process for Service Activation with Number Port Error Resolution

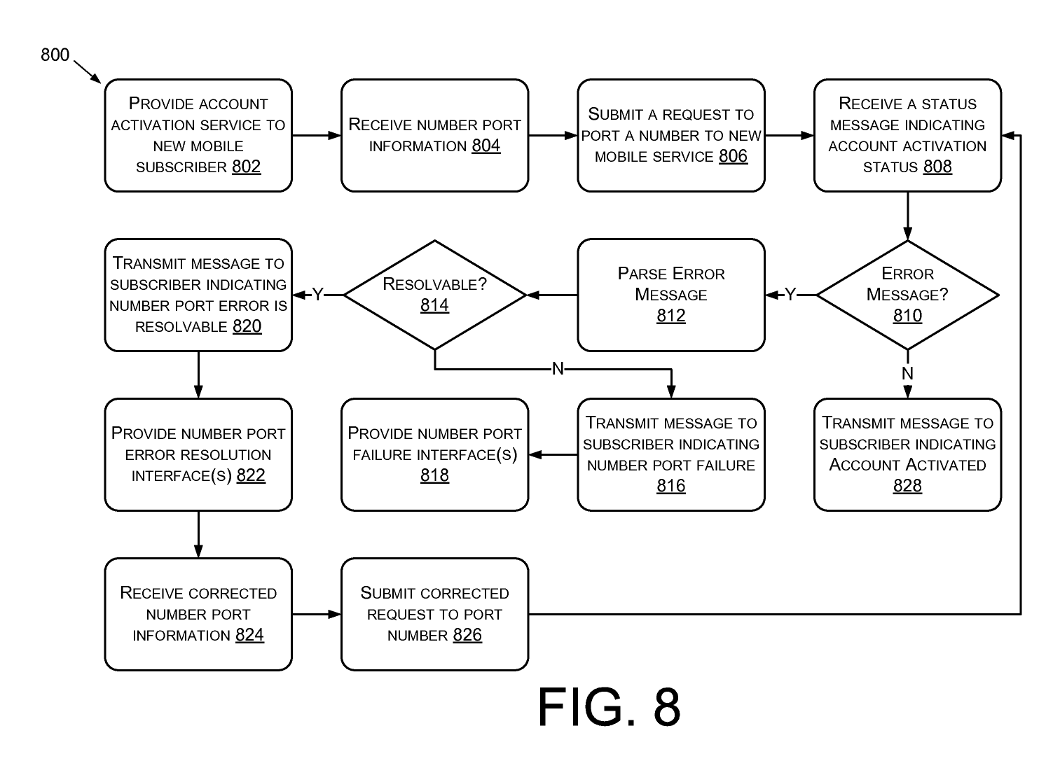

FIG. 8 illustrates an example process 800 for resolving a number port error during service activation. At 802, an account activation module, such as the account activation module 116, provides an account activation service to a new service subscriber, such as by providing user interface screens. The account activation service may be provided upon a new member, such as new member 102, of a social commerce platform receiving his or her new mobile device 104 or SIM card 106. Upon receiving the new mobile device or SIM card, the new member 102 may access the account activation module 116, such as via the web service 118, to activate their new service account. The new member may select to port an existing telephone number from an old service to the new service.

At 804, the account activation module receives number port information, such as one or more of a telephone number to be ported and credentials of the new member with regard to his or her old carrier. For example, the number port information may include a username, account number, password, personal identification number (PIN), social security number, passphrase, or other credential information that the subscriber utilizes to access his or her account with the old service provider, or that otherwise provides the account activation module with sufficient authorization to port the mobile number from the old carrier.

At 806, the account activation module submits or transmits an account activation request to a carrier activation service, such as the carrier activation service 122. The account activation request includes number port information, such as the subscriber's credential information and the subscriber's existing telephone number to be ported. The account activation request may include other information as well, including a SIM card number, a device type, the subscriber's name, address, social security number, and other information that the carrier activation service uses to activate service on behalf of the subscriber.

At 808, the account activation module receives a message from the carrier activation service indicating a status of the account activation. The message may include an error message or error code, indicating one or more errors in the account activation. The error message or error code may indicate that there has been a number port error.

Upon determining at 810 that the status message indicates a number port error, the account activation module parses the error message at 812 to determine whether the number port error is resolvable, or whether the number port error indicates a number port failure. A number port error is resolvable, for example, when the number port request includes missing or incorrect number port information, such as an incorrect or missing telephone number, user credential, or other information. The error message or error code provided by the carrier activation service may indicate the nature of the number port error and whether the number port error is caused by missing or incorrect number port information, or due to some other issue known or unknown.

Based at least on a determination at 814 that the number port error is not resolvable (e.g., is a number port failure), at 816 the account activation module transmits, or causes to be transmitted, to a device associated with the subscriber, such as the personal computer 112, a message indicating a number port failure. The message may indicate that the subscriber should contact the customer service and include a telephone number, Universal Resource Locator (URL) or other link type, or other way to contact customer service. In the same or different embodiments, the message may include a URL or other link type for the mobile subscriber to get more information. The message may be an email, a text message, a social networking message, an instant message, a voicemail, or other message type.

At 818, the account activation module may provide, such as via the web service, a user interface, such as the user interface 600, which provides a URL, phone number, or other way for the subscriber to contact customer service. The user interface screen 600 may also include a selectable option to activate the service with a newly assigned phone number, rather than with a ported phone number. In embodiments, the user interface 600 is provided upon the subscriber selecting a URL provided in the message transmitted at 814, or upon logging in to check on the status of their service account activation. In some embodiments, the user interface screen may be provided during the initial account activation process, depending on how quickly the status message is provided to the account activation service by the carrier activation service.

Based at least on a determination at 814 that the number port error is resolvable, at 820 the account activation module transmits, or causes to be transmitted to a device associated with the subscriber, such as the personal computer 112, a message indicating that a port number error is resolvable. The message may include Universal Resource Locator (URL) or other link to reach a number port resolution user interface screen, such as the user interface 700. The message may be an email, a text message, a social networking message, an instant message, a voicemail, or other message type.

At 822, the account activation module, such as via the web service, provides one or more user interfaces, such as for example, the user interface 700. User interface 700 may be provided upon selection of the URL or other link type within the message provided at 820, upon the mobile subscriber logging in to check on their account activation status, or during the initial account activation process, depending on how quickly the status message is provided to the account activation module by the carrier activation service. The one or more user interfaces enable the mobile subscriber to enter corrected number port information, such as a corrected telephone number, corrected credentials, corrected SIM card number, or other information.

At 824, the account activation module receives, such as via the web service, the corrected number port information after it has been entered and submitted by the subscriber.

At 826, the account activation module submits or transmits a corrected number port request, including the corrected number port information, to the carrier activation service. Upon submission of the corrected request, the process returns to 808 when the account activation service receives a new status message from the carrier activation service. Upon a determination at 810 that the new status message includes an error, the process moves again to 812. Upon a determination at 810 that the status message includes no error messages or error codes, the process proceeds to 828 and the account activation module transmits or causes to be transmitted a message indicating that the account is activated. If the mobile subscriber logs in to see a status of the account activation, he or she may be presented with a user interface screen that indicates that the account is activated and/or that the mobile subscriber's telephone number has been ported to the new mobile service.

### Example Computing System

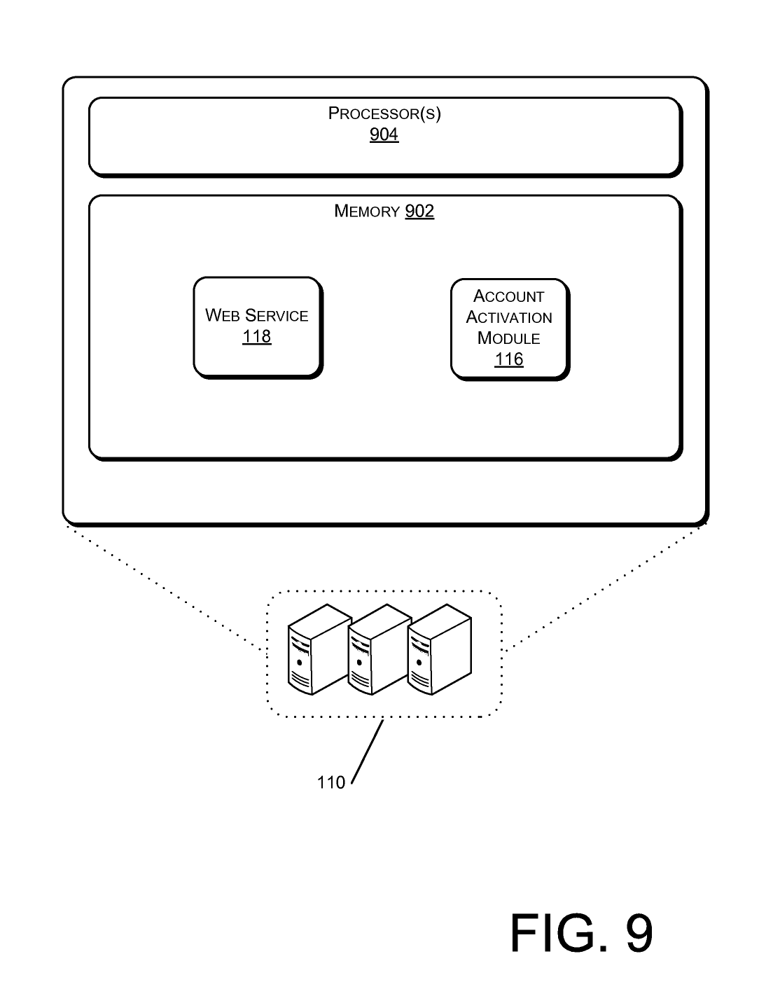

FIG. 9 is a block diagram of an example computing system usable to provide the social commerce platform. The social commerce platform 110 may be configured as any suitable computing device or computing devices capable of implementing service prequalification services. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 902 may store program instructions that are loadable and executable on the processor(s) 904, as well as data generated during execution of, and/or usable in conjunction with, these programs. For example, the memory 902 includes the web service 118 and the account activation module 116.

### Computer-Readable Media

Depending on the configuration and type of computing device used, memory 902 may include volatile memory (such as random access memory (RAM)) and/or non-volatile memory (such as read-only memory (ROM), flash memory, etc.). Memory 902 may also include additional removable storage and/or non-removable storage including, but not limited to, flash memory, magnetic storage, optical storage, and/or tape storage that may provide non-volatile storage of computer-readable instructions, data structures, program modules, and other data.

Memory 902 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### Conclusion

Although the disclosure uses language that is specific to structural features and/or methodological acts, the invention is not limited to the specific features or acts described. Rather, the specific features and acts are disclosed as illustrative forms of implementing the invention.

We claim:

1. A system, comprising:
one or more processors;
memory; and
a plurality of instructions stored on the memory that are executable by the one or more processors to:
transmit to a carrier activation service, a request to port a telephone number from an existing service of a subscriber to a new service of the subscriber;
receive in response to the request, from the carrier activation service, an error message that indicates a number port error;
determine, based on the error message, that the number port error is resolvable; and
provide, based on the determination that the number port error is resolvable, to a device associated with the subscriber, a user interface that enables the subscriber to cause submission of a corrected request to port the telephone number.

2. The system of claim 1, wherein the plurality of instructions are further executable by the one or more processors to:
determine, based on the error message, that the number port error is a number port failure; and
cause to be transmitted to the device associated with the subscriber, based on the determination that the number port error is a number port failure, a message that indicates that the new subscriber should contact the customer service.

3. The system of claim 1, wherein the plurality of instructions are further executable to cause a message to be transmitted to the device, or an account associated with the subscriber, including a selectable link to access the resolution user interface.

4. The system of claim 1, wherein the request includes one or more of the telephone number and credentials associated with the subscriber with regards to the existing service, and wherein the determination includes parsing the error message to determine whether one or more of the telephone number or the credentials were incorrect within the request.

5. The system of claim 4, wherein the plurality of instructions are further executable by the one or more processors to receive, via the resolution user interface, one or more of a corrected telephone number or corrected credentials to generate the corrected request.

6. The system of claim 1, wherein the transmission of the request to the carrier activation service includes calling an Application Programming Interface of the carrier activation service.

7. The system of claim 1, wherein the plurality of instructions are further executable to provide an account activation service to the device or another device associated with the subscriber, the account activation service including receiving number port information from the device or the other device, and wherein the request includes the number port information.

8. One or more computer-readable storage media having instructions stored thereon that are executable by one or more processors to:
submit a request to a carrier activation service, the request indicating a telephone number from a subscriber's existing carrier to the subscriber's new carrier;
determine, based on an error message received from the carrier activation service, whether a number port error is resolvable; and
cause to be displayed on a device associated with the subscriber, based at least on the determination, a number port correction user interface screen to enable the subscriber to correct the number port error.

9. The one or more computer-readable storage media of claim 8, wherein the number port correction user interface screen includes an option to re-enter number port information, and wherein the instructions are further executable by the one or more processors to submit a corrected number port request to the carrier activation service, the corrected request including the re-entered number port information.

10. The one or more computer-readable storage media of claim 9, wherein the re-entered number port information includes one or more of the telephone number and credentials of the subscriber.

11. The one or more computer-readable storage media of claim 9, wherein the determination includes parsing the error message to determine that the number port failure is caused by missing or incorrect information in the request.

12. The one or more computer-readable storage media of claim 8, wherein the number port correction user interface screen includes an option to contact a customer service.

13. The one or more computer-readable storage media of claim 8, wherein the number port correction user interface screen enables the subscriber to request a new telephone number and to cancel the number port request.

14. A method, comprising:
transmitting a request to a carrier activation service, the request to activate a new service for a subscriber, the request including information regarding a telephone number to port as part of a new service being activated for the subscriber;
receiving an error message received from the carrier activation service in response to the request, the error message indicating a number port error; and
transmitting to a device associated with the subscriber, based at least on the error message, a message including instructions for or a link to a number port correction user interface that enables the subscriber to resolve the number port error.

15. The method of claim 14, further comprising determining, based on the error message, that the number port failure is caused by missing or incorrect information in the request, wherein the number port correction user interface enables entry of corrected information and to cause submission of a corrected request having the corrected information.

16. The method of claim 15, wherein the incorrect information includes one or more of the telephone number and credentials of the subscriber with respect to an existing mobile service.

17. The method of claim 15, wherein the number port correction user interface indicates the missing or incorrect information to be corrected.

18. The method of claim 14, further comprising determining, based on the error message, that the number port failure is caused by something other than missing or incorrect information in the request, wherein the number port correction user interface enables contacting of a customer service representative.

19. The method of claim 14, wherein the transmitting the request to the carrier activation service includes calling an Application Programming Interface of the carrier activation service.

20. The method of claim 14, wherein the number port correction user interface screen enables the subscriber to request a new telephone number and to cancel the number port request.
